(19) United States
(12) Patent Application Publication
(10) Pub. No.: US 2014/0312543 A1
(43) Pub. Date: Oct. 23, 2014

(54) SILENCER FOR LAMINATED LEAF SPRING, AND LAMINATED LEAF SPRING

(71) Applicant: OILES CORPORATION, Tokyo (JP)

(72) Inventors: Noboru Nakagawa, Fujisawa (JP); Takashi Horiguchi, Fujisawa (JP)

(21) Appl. No.: 14/354,889

(22) PCT Filed: Nov. 9, 2012
(86) PCT No.: PCT/JP2012/079078

§ 371 Date: Apr. 28, 2014

(30) Foreign Application Priority Data
Dec. 22, 2011 (JP) 2011-282380

(51) Int. Cl. F16F 1/26; B60G 11/02; F16F 1/18

(52) U.S. Cl. CPC F16F 1/26; F16F 1/18; B60G 11/02
USPC 267/158

(57) ABSTRACT

Provided is a silencer for a laminated leaf spring, with which it is possible to more effectively reduce abnormal noise generated in conjunction with deflection of the laminated leaf spring, as compared to when a conventional silencer for a laminated leaf spring is used. This silencer (1) for a laminated leaf spring is arranged between adjacent leaf springs (60a-60c) in the direction in which the multiple leaf springs (60a-60c) forming a laminated leaf spring (6) are stacked. A thermoplastic elastomer that has lower hardness than thermoplastic synthetic resins such as polyethylene resin, polyacetal resin, polyamide resin, and polyester resin, and that has a better sliding characteristic than rubber materials such as natural rubber and synthetic rubber, is used for the material of the silencer (1).

### TECHNICAL FIELD

The present invention relates to a laminated leaf spring for vehicles, more particularly relates to a silencer for preventing abnormal noise, which is used for the laminated leaf spring for vehicles.

### BACKGROUND ART

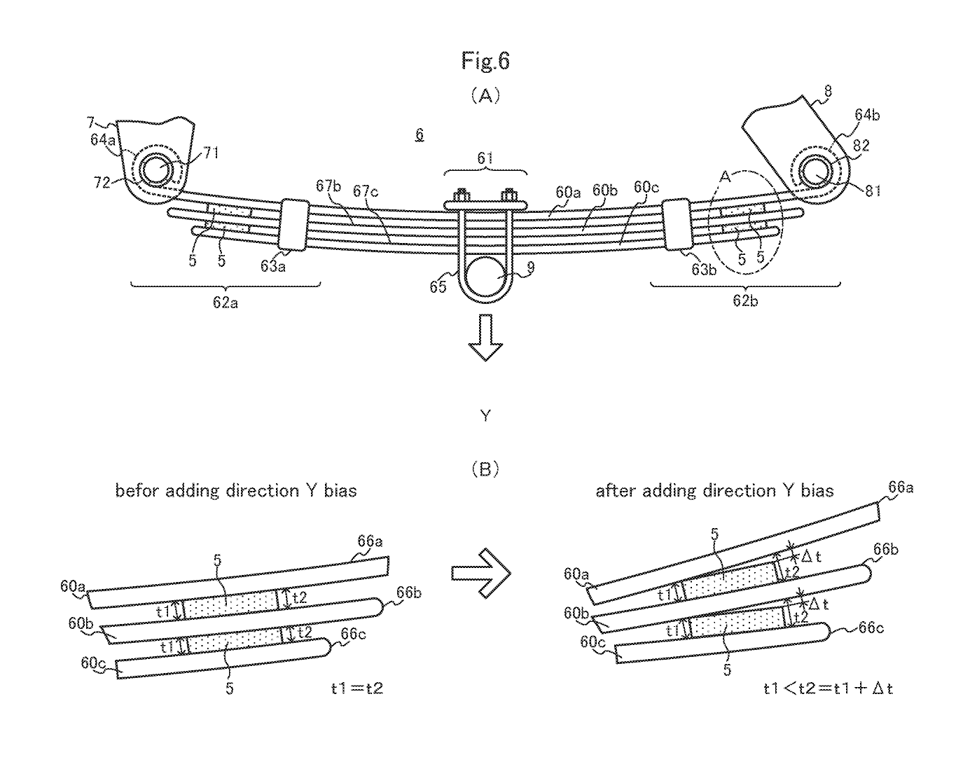

A laminated leaf spring (a leaf-type suspension) is known as a suspension connecting a vehicle body and an axel shaft. As shown in FIG. 6(A), a laminated leaf spring 6 is configured so that plural leaf springs 60a-60c (also simply referred to as leaf springs 60 hereinafter) are stacked and bundled at both end parts 62a and 62b by clips 63a and 63b. A central part 61 of the laminated leaf spring 6 is fitted to an axle shaft (axle) 9 on front wheels or rear wheels by a U bolt 65.

The longest leaf spring 60a of the plural leaf springs 60 is referred to as a main spring. The both end parts 62a and 62b of the main spring 60a are curled to form shaft insert parts 64a and 64b. A bush 72, which holds slidably a pivot (fixed axis) 71, is housed in the one shaft insert part 64a. This pivot 71 is secured to the vehicle body not shown in the figures via a bracket 7. In the other shaft insert part 64b, a bush 82, which holds slidably a shaft 81 of a shackle 8 connected to the vehicle body, is housed. Thus, one end part 62a of the laminated leaf spring 6 is secured to the vehicle body with the pivot 71, and the other end part 62b of the laminated leaf spring 6 is connected to the vehicle body by the shackle 8.

With such a configuration, the laminated leaf spring 6 pushes the axle shaft 9 against a road surface and enhances a grip force of wheels not shown in the figures, so as to stabilize moving of the vehicle and to prevent propagation of vibration received from bumps of the road surface via the axle shaft 9 while the vehicle is moving.

By the way, when the axle shaft 9 moves up and down, the central part 61 moves up and down, and the laminated leaf spring 6 bends in an arch shape. It causes relative slipping of the leaf springs 60 adjacent in a stacked direction at the both end parts 62a and 62b and generating abnormal noise in the case of rubbing metals each other. Therefore, as shown in FIG. 6(A), abnormal noise generated by rubbing metals each other is prevented by interposing a rubber silencer 5 between the leaf springs 60 adjacent in a stacked direction at the both end parts 62a and 62b.

For example, patent literature 1 discloses a silencer of rubber molded article, which comprises a plate-like base part arranged between adjacent leaf springs in a stacked direction and a cylindrical mounting shaft part press-fitted and held into a mounting hole provided on a leaf spring in a manner protruding from one surface of the plate-like base part. In this silencer, a reinforcing metal fitting, which bridges between the plate-like base part and the mounting shaft part is embedded in a root part of the mounting shaft part. Furthermore, plural mountain parts, which project outside in a radial direction and extend axially, and plural valleys, which depress in inner side in a radial direction and extend axially, are alternately arranged on outer periphery of the mounting shaft part in a circumferential direction. Such a configuration ensures sufficient durability and excellent assemblability while using rubber as a material of the silencer.

### CITATION LIST

### Patent Literature

[Patent Literature 1] Japanese Unexamined Patent Application Publication No. 2007-247754.

### SUMMARY OF INVENTION

### Technical Problem

By the way, when relative slipping between the leaf springs 60 adjacent in a stacked direction via the silencers 5 occurs by the laminated leaf spring 6 being bended, the rubber silencers 5 restrain sliding of the silencers 5 and the leaf springs 60, which contact with the silencers 5, and prevents abrasion and abnormal noise due to the sliding, and improves durability, by utilizing a easily and elastically deformable property of the rubber silencer 5.

However, when comparatively large relative slipping exceeding a elastically deformable domain of rubber occurs between the leaf springs 60 adjacent in a stacked direction via the rubber silencers 5, the rubber silencers 5 and the leaf springs 60, which contact with the silencers 5, slide each other. Since rubber materials generally do not have a good sliding characteristic, sliding of the rubber silencers 5 and the leaf springs 60 is more likely to generate abnormal noise due to stick-slip and the like. Furthermore, the sliding causes rubber abrasion and deterioration, and reduces durability of the silencers 5.

It is noted that it is possible to reduce abnormal noise in the case of sliding of the silencers 5 and the leaf springs 60, by using the silencers 5 made of thermoplastic synthetic resin having a good sliding characteristic such as polyethylene resin, polyacetal resin, polyamide resin and polyester resin. However, the use of thermoplastic synthetic resin increases stiffness of the silencer 5. As a result, even if the laminated leaf spring 6 is slightly bended, the silencers 5 and the leaf springs 60, which contact with the silencers 5, slide each other. That is, the use of thermoplastic synthetic resin increases frequency of sliding of the silencers 5 and the leaf springs 60, and increases probability of occurring of abnormal noise, as compared to the case using rubber. Also, since sliding is accompanied by friction, durability will be decreased. In addition, its effect absorbing impact and the like will be also decreased.

The present invention has been made in view of the above circumstances, and its object is to provide a silencer for laminated leaf spring which can reduce more effectively abnormal noise caused by bending of the laminated leaf spring than in the case of using a silencer for laminated leaf spring made of conventional rubber materials or thermoplastic synthetic resin.

### Solution to Problem

In order to solve the problem described above, the silencer for laminated leaf spring of the present invention adopts a thermoplastic elastomer having lower stiffness than that of thermoplastic synthetic resin and having a better sliding characteristic than that of rubber, as a material. Also, as necessary, other agent such as fluorinated resin or a silicon lubricant is added to further improve a sliding characteristic.

### Advantageous Effect of Invention

A thermoplastic elastomer can become easily and elastically deformed since it has lower stiffness than that of thermoplastic synthetic resin. For this reason, the silencer for laminated leaf spring of the present invention can adapt, by its elastic deformation, to relative slipping between the adjacent leaf springs in a stacked direction, as compared to the silencer made of thermoplastic synthetic resin. Therefore, relative slipping between the silencer for laminated leaf spring and the leaf spring may be restrained to reduce abnormal noise.

Furthermore, a thermoplastic elastomer has a better sliding characteristic than that of rubber. Thus, according to the silencer for laminated leaf spring of the present invention, abnormal noise caused by relative slipping between the adjacent leaf springs in a stacked direction can be reduced, as compared to the rubber silencer, by relative slipping between the silencer for laminated leaf spring and the leaf spring.

Thus, according to the present invention, abnormal noise generated by bending of the laminated leaf spring can be reduced more effectively, as compared to the case of using the silencers for laminated leaf spring made of conventional rubber materials or thermoplastic synthetic resin.

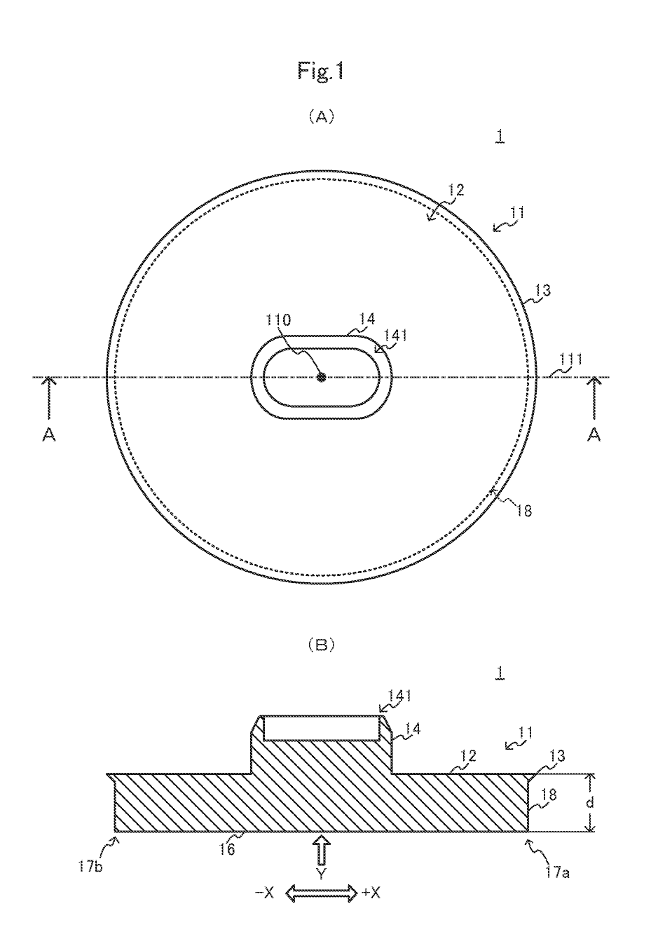

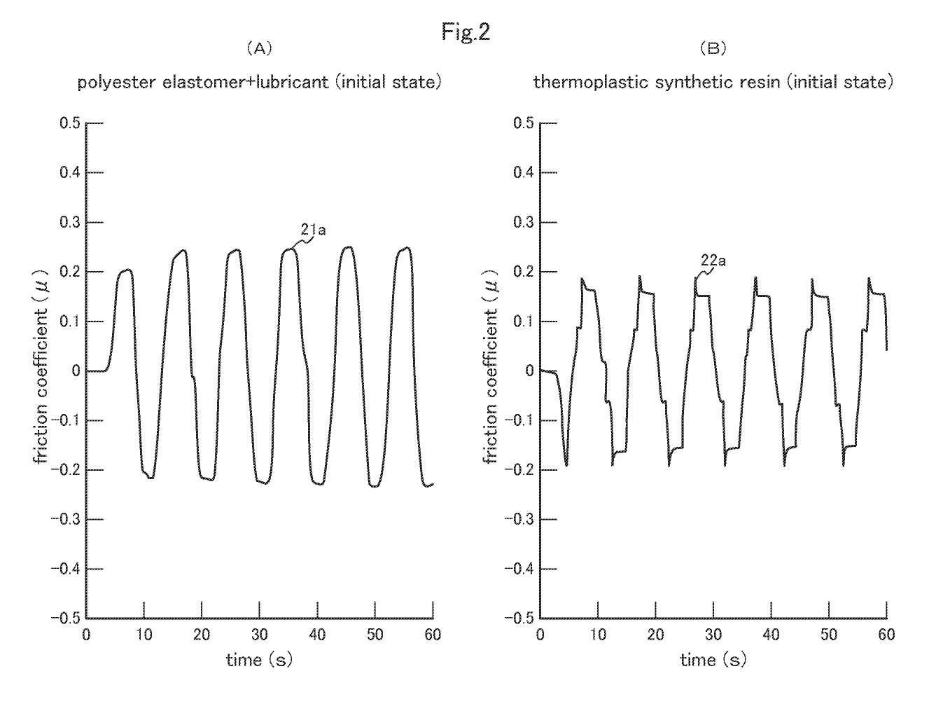

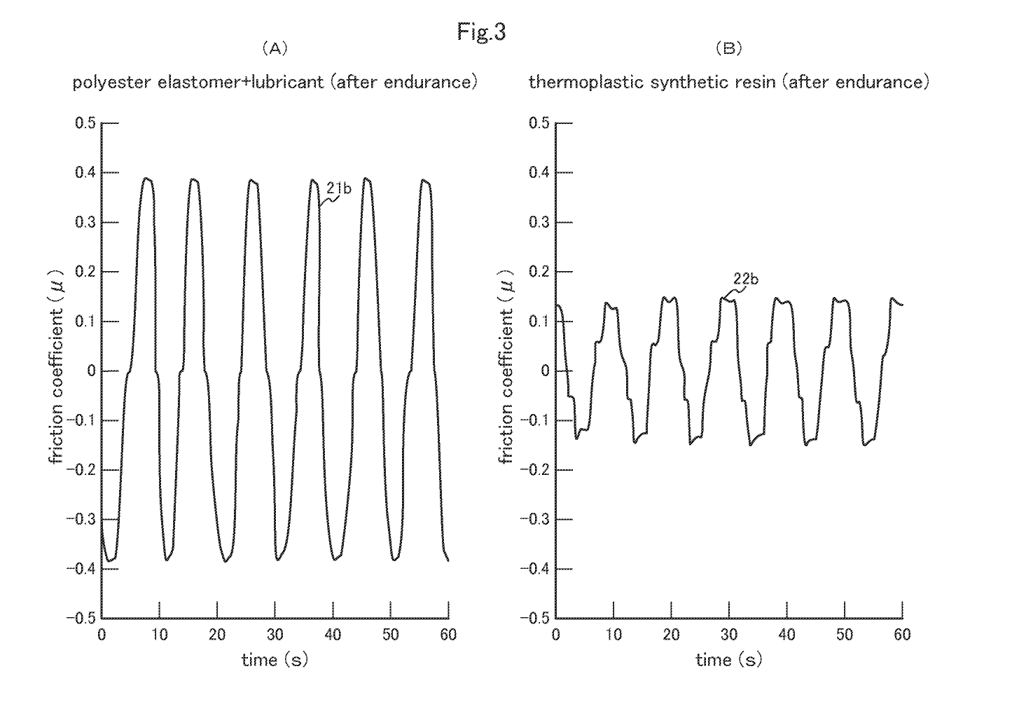

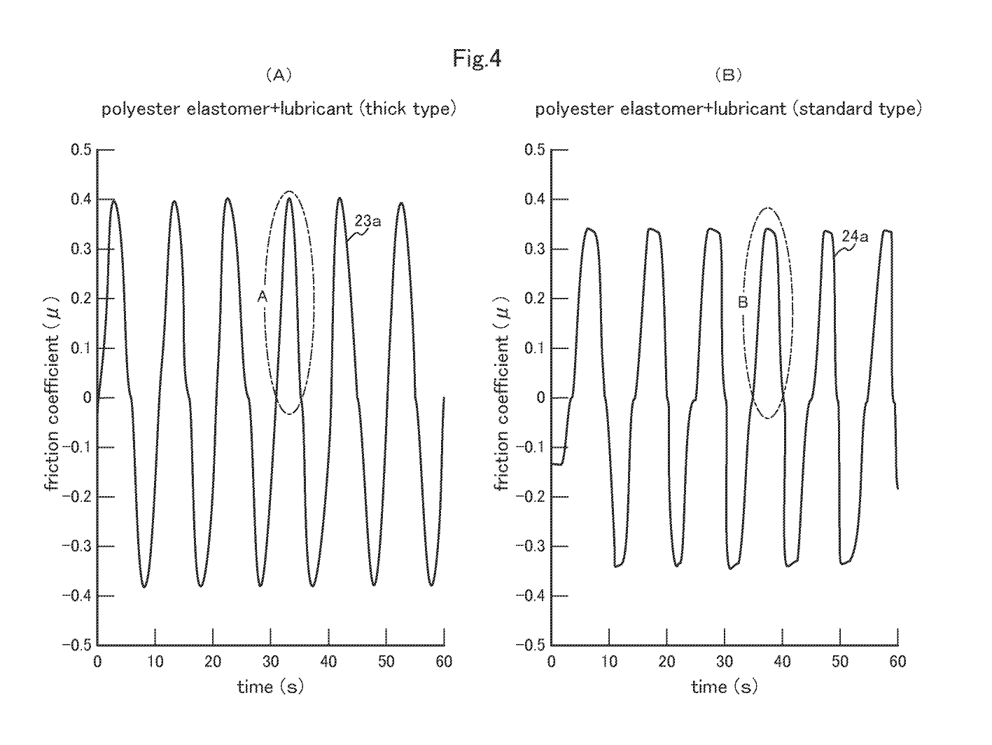

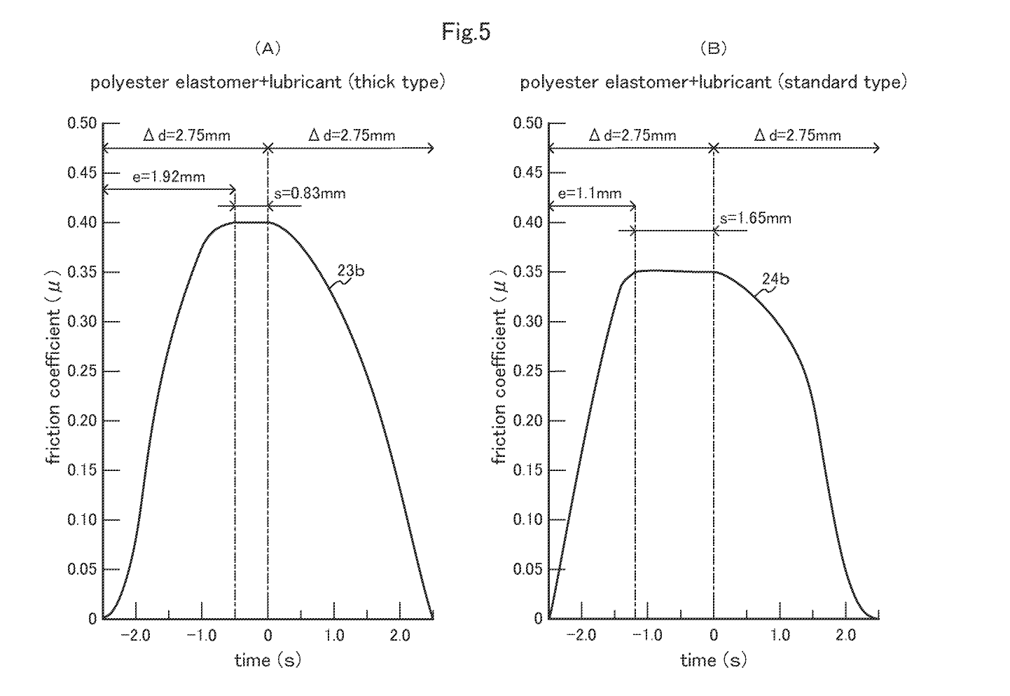

### BRIEF DESCRIPTION OF DRAWING

[FIG. 1] FIG. 1(A) is a front view of a silencer 1 for laminated leaf spring according to one embodiment of the present invention, and FIG. 1(B) is an A-A cross-section view of the silencer 1 for laminated leaf spring as shown in FIG. 1(A).

[FIG. 2] FIGS. 2(A) and 2(B) are views showing experimental data with respect to time-friction coefficient characteristics at the initial state (from immediately after test start to one hour progress) in planar reciprocation tests performed for the silencer 1 for laminated leaf spring made of a material in which a silicon lubricant or a fluorinated lubricant is added to a polyester elastomer and the silencer 1 for laminated leaf spring 1 made of thermoplastic synthetic resin respectively.

[FIG. 3] FIGS. 3(A) and 3(B) are views showing experimental data with respect to time-friction coefficient characteristics after endurance (from two hour progress after test start to three hour progress) in planar reciprocation tests performed for the silencer 1 for laminated leaf spring made of a material in which a silicon lubricant or a fluorinated lubricant is added to a polyester elastomer and the silencer 1 for laminated leaf spring made of thermoplastic synthetic resin respectively.

[FIG. 4] FIG. 4(A) and 4(B) are views showing experimental data with respect to time-friction coefficient characteristics after predetermined time progress in planar reciprocation tests performed for the silencers 1 for laminated leaf spring with varied thickness d (thick, normal) made of a material in which a silicon lubricant or a fluorinated lubricant is added to a polyester elastomer.

[FIG. 5] FIG. 5(A) is an enlargement view of a part A (corresponding to half stroke of the planar reciprocation) in FIG. 4(A), and FIG. 5(B) is an enlargement view of a part B (corresponding to half stroke of the planar reciprocation) in FIG. 4(B).

[FIG. 6] FIG. 6(A) is an explanation view of a schematic configuration of a laminated leaf spring 6, and FIG. 6(B) is an enlargement view of a part A of FIG. 6(A) for explaining problems of a conventional silencer 5 occurring when load is applied to the laminated leaf spring 6.

### DESCRIPTION OF EMBODIMENTS

In the following, an embodiment of the present invention will be described referring to the drawings.

FIG. 1(A) is a front view of a silencer 1 for laminated leaf spring according to the present embodiment, and FIG. 1(B) is an A-A sectional view of the silencer 1 for laminated leaf spring as shown in FIG. 1(A).

As well as the above-mentioned conventional silencer 5, the silencer 1 for laminated leaf spring according to the present embodiment is used for reducing abnormal noise caused by relative slipping of the adjacent leaf springs 6 in a stacked direction at the both end parts 62a and 62b of the laminated leaf spring 6. And the silencers 1 for laminated leaf spring are disposed between the leaf springs 60 adjacent in a stacked direction at the both end parts 62a and 62b of the laminated leaf spring 6 (see FIG. 6(A)).

As shown in FIGS. 1(A) and 1(B), the silencer 1 for laminated leaf spring according to the present embodiment comprises a disk-like silencer body 11, and a fitting part 14 formed integrally in a central part on one surface (upper surface) 12 of the silencer body 11.

For a vehicle equipped with the laminated leaf spring 6, the silencer body 11 is formed such that thickness of the silencer body 11 is larger than an assumed maximum value of a gap between the leaf springs 60 adjacent in a stacked direction at a disposed position of the silencer 1 for laminated leaf spring by bending of the laminated leaf spring 6. That is, the silencer body 11 is formed such that thickness d of the silencer body 11 is larger than a maximum value of gaps t1 and t2 between the leaf springs 60 adjacent in a stacked direction at the disposed positions of the both end parts 17a and 17b of the silencer body 11(see FIG. 6(B)), in the cross-section A-A.

Around a rim of a top surface 12 of the silencer body 11, a flange 13 is formed to stick out from a side surface 18 of the silencer body 11 for improving mold releasability to prevent sticking to a fixing mold.

A fitting part 14 has an elliptic cylindrical shape and fits with an elongate hole or a groove, not shown in figures, formed on upper surfaces 67b and 67c of leaf springs 60b and 60c.

Materials used for the silencer 1 for laminated leaf spring include a thermoplastic elastomer having higher elasticity (lower stiffness) than that of thermoplastic synthetic resin such as polyethylene resin, polyacetal resin, polyamide resin and polyester resin and having a better sliding characteristic than rubber materials such as natural rubber and synthetic rubber.

Particularly suitable materials for the silencer 1 for laminated leaf spring include a material in which predetermined amount of fatty acid, metal soap, phosphoric salts and lubricant oil are added to a polyester elastomer, and a material in which a silicon lubricant or a fluorinated lubricant is added to a polyester elastomer.

The inventors performed property tests respectively against the silencer 1 for laminated leaf spring 1 which is made of a material in which a silicon lubricant or a fluorinated lubricant is added to a polyester elastomer, and the silencer 1 for laminated leaf spring 1 which is made of thermoplastic synthetic resin.

Specifically, in a condition in which the fitting part 14 and the upper surface 12 of the silencer body 11 were completely fixed by jigs at an ambient temperature of 80 degree centigrade, predetermined load (2.6 Mpa of surface pressure in the tests) was applied to the silencer body 11 in a direction from the lower surface 16 to the upper surface 12 (a direction Y in FIG. 1(B)), by the leaf springs 60. And the leaf springs 60 were allowed to reciprocate in a direction of a line 111 passing through a center 110 of the silencer body 11 (a direction±X in FIG. 1(B)) at predetermined speed (0.1 Hz in the tests) and predetermined stroke (±2.75 mm in the tests). And temporal change of friction coefficient was observed during this test (planar reciprocation tests).

FIGS. 2(A) and 2(B) are views shown experimental data with respect to time-friction coefficient characteristics at the initial state (from immediately after test start to one hour progress) in the planar reciprocation tests performed for the silencer 1 for laminated leaf spring made of a material in which a silicon lubricant or a fluorinated lubricant is added to a polyester elastomer and the silencer 1 for laminated leaf spring made of thermoplastic synthetic resin respectively.

Furthermore, FIGS. 3(A) and 3(B) are views showing experimental data with respect to time-friction coefficient characteristics after endurance (from two hour progress after the test start to three hour progress) in the planar reciprocation tests performed for the silencer 1 for laminated leaf spring made of a material in which a silicon lubricant or a fluorinated lubricant is added to a polyester elastomer and the silencer 1 for laminated leaf spring made of thermoplastic synthetic resin respectively.

Here diameter T and thickness d of all the test samples were set to about 50 mm and about 3 mm respectively.

As shown in the experimental data 21a and 22a of time-friction coefficient characteristics in FIGS. 2(A) and 2(B), in the initial state, the silencer 1 for laminated leaf spring made of a material in which a silicon lubricant or a fluorinated lubricant is added to a polyester elastomer has a friction coefficient 1.4 times higher than that of the silencer 1 for laminated leaf spring made of thermoplastic synthetic resin. And variation of a friction coefficient of the silencer 1 for laminated leaf spring made of a material in which a silicon lubricant or a fluorinated lubricant is added to a polyester elastomer shows a smoother curve (sinusoidal wave) than that of the silencer 1 for laminated leaf spring made of thermoplastic synthetic resin.

In a case of the silencer 1 for laminated leaf spring made of a material in which a silicon lubricant or a fluorinated lubricant is added to a polyester elastomer, due to planar reciprocation, at first elastic deformation of the silencer 1 for laminated leaf spring occurs and then relative slipping between the silencer 1 for laminated leaf spring and the leaf spring 60 occurs. Therefore, it shows that relative slipping between the silencer 1 for laminated leaf spring and the leaf spring 60 is kept lower than the silencer 1 for laminated leaf spring made of thermoplastic synthetic resin. Also, it shows that the relative slipping becomes smoother. Thus, by using a material in which a silicon lubricant or a fluorinated lubricant is added to a polyester elastomer, as the silencer 1 for laminated leaf spring, it is demonstrated that abnormal noise caused by relative slipping between the silencer 1 for laminated leaf spring and the leaf spring 60 may be reduced more effectively.

Moreover, as shown in the experimental data 21b and 22b for time-friction coefficient characteristics in FIGS. 3(A) and 3(B), variation of a friction coefficient in after endurance of the silencer 1 for laminated leaf spring made of thermoplastic synthetic resin is less than variation of a friction coefficient in initial state of the same silencer 1. On the other hand, variation of a friction coefficient in after endurance of the silencer 1 for laminated leaf spring made of a material in which a silicon lubricant or a fluorinated lubricant is added to a polyester elastomer is larger than variation of a friction coefficient in initial state of the same silencer 1.

In a case that thermoplastic synthetic resin is used for the silencer 1 for laminated leaf spring, a friction coefficient is decreased due to a long period use, and then relative slipping between the silencer 1 for laminated leaf spring and the leaf springs 60 tends to become larger. On the other hand, in a case that a material in which a silicon lubricant or a fluorinated lubricant is added to a polyester elastomer is used for the silencer 1 for laminated leaf spring, a friction coefficient is increased due to a long period use, and then relative slipping between the silencer 1 for laminated leaf spring and the leaf springs 60 tends to become smaller. Thus, by using a material in which a silicon lubricant or a fluorinated lubricant is added to a polyester elastomer, as the silencer 1 for laminated leaf spring, it is demonstrated that abnormal noise caused by relative slipping between the silencer 1 for laminated leaf spring and the leaf spring 60 is reduced more effectively for a long period.

Furthermore, the inventors performed property tests respectively against the silencers 1 for laminated leaf spring with varied thickness d made of a material in which a silicon lubricant or a fluorinated lubricant is added to a polyester elastomer.

Particularly, in a condition that the fitting part 14 and the upper surface 12 of the silencer body 11 were completely fixed by jigs at an ambient temperature of 80 degree centigrade, predetermined load (2.6 Mpa of surface pressure in the tests) was applied to the silencer body 11 in a direction from the lower surface 16 to the upper surface 12 (a direction Y in FIG. 1(B)), by the leaf springs 60. And the leaf springs 60 were allowed to reciprocate in a direction of the line 111 passing through the center 110 of the silencer body 11 (a direction X in FIG. 1(B)) at predetermined speed (0.1 Hz in the tests) and predetermined stroke (±2.75 mm in the tests). And temporal change of friction coefficient was observed during the tests (the planar reciprocation tests).

FIGS. 4(A) and 4(B) are views showing experimental data with respect to time-friction coefficient characteristics after predetermined time progress in the planar reciprocation tests performed for the silencers 1 for laminated leaf spring with varied thickness d (thick, normal) made of a material in which a silicon lubricant or a fluorinated lubricant is added to a polyester elastomer.

FIG. 5 (A) is an enlargement view of a part A (corresponding to half stroke of the planar reciprocation) in FIG. 4(A), and FIG. 5(B) is an enlargement view of a part B (corresponding to half stroke of the planar reciprocation) in FIG. 4(B). Here time axis (s) is offset such that time is set to 0 when displacement Δd in the planar reciprocation is minimal value (0 mm).

Here, thicknesses d of a standard type sample is set to about 3 mm, and thicknesses d of a thick type sample is set to about 5.5 mm. And each diameter φ of them is set to about 50 mm.

As shown in experimental data 23a and 24a of time-friction coefficients property in FIGS. 4(A) and 4(B), the thick type silencer 1 for laminated leaf spring has a friction coefficient about 1.1 times higher than the standard type silencer 1 for laminated leaf spring. And variation of a friction coefficient of the thick type silencer 1 for laminated leaf spring shows a smoother curve (sinusoidal wave) than the standard type silencer 1 for laminated leaf spring.

Furthermore, as shown in FIG. 5(B), in a case of the standard type sample, when displacement amount e reaches about 1.1 mm, relative slipping between the silencer 1 for laminated leaf spring and the leaf spring 60 occurs, and its slipping amount is about 1.65 mm. On the other hand, as shown in FIG. 5(A), in a case of the thick type sample, when displacement amount e reaches about 1.92 mm, relative slipping between the silencer 1 for laminated leaf spring and the leaf spring 60 occurs, and its slipping amount is about 0.83 mm.

In a case of the thick type silencer 1 for laminated leaf spring, due to strength of its elastic biasing force, relative slipping between the silencer 1 and the leaf spring 60 is restrained and becomes smoother, as compared to the standard type silencer 1 for laminated leaf spring. Thus, by increasing thicknesses d1 and d2 of the silencer 1 for laminated leaf spring, it is demonstrated that abnormal noise caused by relative slipping between the silencer 1 for laminated leaf spring and the leaf spring 60 is reduced more effectively.

One embodiment of the present invention has been described above.

In the present embodiment, a thermoplastic elastomer is used as a material for the silencer 1 for laminated leaf spring. A thermoplastic elastomer can become easily and elastically deform since it has lower stiffness than that of thermoplastic synthetic resin such as polyethylene resin, polyacetal resin, polyamide resin and polyester resin. For this reason, the silencer 1 for laminated leaf spring according to the present embodiment can adapt, by its elastic deformation, to relative slipping between the leaf springs 60 adjacent in the stacked direction, as compared to the silencers made of thermoplastic synthetic resin. Therefore, relative slipping between the silencer 1 for laminated leaf spring and the leaf spring 60 may be restrained to reduce abnormal noise.

Furthermore, a thermoplastic elastomer has a better sliding characteristic than that of rubber such as natural rubber and synthetic rubber. Thus, according to the silencer 1 for laminated leaf spring of the present embodiment, abnormal noise caused by relative slipping between the leaf springs 60 adjacent in a stacked direction can be reduced, as compared to the rubber silencer, by relative slipping between the silencer 1 for laminated leaf spring and the leaf spring 60.

Furthermore, in the present embodiment, the silencer 1 for laminated leaf spring is molded such that thickness d of the silencer 1 becomes greater than a maximum value of gaps t1 and t2 between the leaf springs 60 adjacent in a stacked direction among the plural leaf springs 60 constituting the laminated leaf spring 6. By the way, in the conventional silencer 5, when a shape of the laminated leaf spring 6 becomes steep arch because of bending of the laminated leaf spring 6 being increased by adding downward (a direction Y shown in FIG. 6(A)) bias to the laminated leaf spring 6 due to e.g. turn of a vehicle, gaps t2 between the leaf springs 60 adjacent at the end parts 62a and 62b become wider than gaps t1 at the central part 61. thereby, gaps Δt are formed between the silencers 5 and the leaf springs 60 at the tips 66a-66c of the leaf springs 60, as shown in FIG. 6(B). As a result, during a vehicle travel, dirt and mud enter the gaps Δt, which cause impairment on the surfaces of the silencers lying next to each other and cause abnormal noise during relative slipping of these silencers. On the other hand, according to the present embodiment, the silencer 1 for laminated leaf spring is molded such that thickness d of the silencer 1 is greater than a maximum value of gaps t1 and t2 between the leaf springs 60 adjacent in a stacked direction. Thereby, the silencer 1 elastically deforms to fill up the gaps t1 and t2 between the leaf springs 60 adjacent in a stacked direction with changes in width of the gaps in response to bending amount of the laminated leaf spring 6 equipped in a vehicle. Therefore, according to the silencer 1 for laminated leaf spring of the present embodiment, entry of dirt and mud into gaps between the leaf spring 60 and the silencer 1 during a vehicle travel can be prevented, thereby the surface of the leaf spring 60 and the surface of the silencer 1 for laminated leaf spring can be protected from impairment.

It is noted that, although the silencer body 11 is in the disk-like form in the present embodiment, it may be in other plate-like form such as rectangular plate-like form and polygonal plate-like form. In addition, the flange 13 may be provided if needed.

Furthermore, in the present embodiment, although the elliptic cylindrical fitting part 14 is provided on the upper surface 12 of the silencer body 11, it may be in any forms as long as it may fit with an elongate hole or a groove on the leaf spring 6. The fitting part 14 may not be provided when the silencer 1 for laminated leaf spring is attached to the leaf springs 60 by other securing means.

### INDUSTRIAL APPLICABILITY

The present invention is widely applicable for a silencer for prevention of abnormal noise which is used for a vehicular laminated leaf spring.

### REFERENCE SIGNS LIST

1 silencer for laminated leaf spring
6 leaf spring
7 bracket
8 shackle
9 axle shaft
11 silencer body
12 upper surface of the silencer body 11
13 flange
14 fitting part
16 lower surface of the silencer body 11
17a end part of the silencer body 11
17b end part of the silencer body 11
18 side surface of the silencer body 11
60 leaf spring
60a leaf spring
60b leaf spring
60c leaf spring

1. A silencer for laminated leaf spring disposed between adjacent leaf springs in stacked direction among plural leaf springs constituting a laminated leaf spring, wherein the silencer is composed of a resin material made of a thermoplastic elastomer.

2. A silencer for laminated leaf spring disposed between adjacent leaf springs in stacked direction among plural leaf springs constituting a laminated leaf spring, wherein the silencer is composed of a resin material in which a silicon lubricant or a fluorinated lubricant is added to a thermoplastic elastomer, or a resin material in which fatty acid, metal soap, phosphate and lubricant oils are added to a thermoplastic elastomer.

3. The silencer for laminated leaf spring according to claim 1, wherein the thermoplastic elastomer is a polyester elastomer.

4. The silencer for laminated leaf spring according claim 1, wherein thickness of the silencer is greater than the maximum value of gap between the adjacent leaf springs at disposed position of the silencer by bending of the laminated leaf spring.

5. A laminated leaf spring constituted by plural leaf springs which are stacked and bundled together, wherein the laminated leaf spring has the silencers for laminated leaf spring according to claim 1 respectively arranged between adjacent leaf springs in stacked direction among the plural leaf springs, at least at both end parts of the laminated leaf spring.

6. The silencer for laminated leaf spring according to claim 2, wherein the thermoplastic elastomer is a polyester elastomer.

7. The silencer for laminated leaf spring according to claim 2, wherein thickness of the silencer is greater than the maximum value of gap between the adjacent leaf springs at disposed position of the silencer by bending of the laminated leaf spring.

8. The silencer for laminated leaf spring according to claim 3, wherein thickness of the silencer is greater than the maximum value of gap between the adjacent leaf springs at disposed position of the silencer by bending of the laminated leaf spring.

9. The silencer for laminated leaf spring according to claim 6, wherein thickness of the silencer is greater than the maximum value of gap between the adjacent leaf springs at disposed position of the silencer by bending of the laminated leaf spring.

10. A laminated leaf spring constituted by plural leaf springs which are stacked and bundled together, wherein the laminated leaf spring has the silencers for laminated leaf spring according to claim 2 respectively arranged between adjacent leaf springs in stacked direction among the plural leaf springs, at least at both end parts of the laminated leaf spring.

11. A laminated leaf spring constituted by plural leaf springs which are stacked and bundled together, wherein the laminated leaf spring has the silencers for laminated leaf spring according to claim 3 respectively arranged between adjacent leaf springs in stacked direction among the plural leaf springs, at least at both end parts of the laminated leaf spring.

12. A laminated leaf spring constituted by plural leaf springs which are stacked and bundled together, wherein the laminated leaf spring has the silencers for laminated leaf spring according to claim 6 respectively arranged between adjacent leaf springs in stacked direction among the plural leaf springs, at least at both end parts of the laminated leaf spring.

13. A laminated leaf spring constituted by plural leaf springs which are stacked and bundled together, wherein the laminated leaf spring has the silencers for laminated leaf spring according to claim 4 respectively arranged between adjacent leaf springs in stacked direction among the plural leaf springs, at least at both end parts of the laminated leaf spring.

14. A laminated leaf spring constituted by plural leaf springs which are stacked and bundled together, wherein the laminated leaf spring has the silencers for laminated leaf spring according to claim 7 respectively arranged between adjacent leaf springs in stacked direction among the plural leaf springs, at least at both end parts of the laminated leaf spring.

15. A laminated leaf spring constituted by plural leaf springs which are stacked and bundled together, wherein the laminated leaf spring has the silencers for laminated leaf spring according to claim 8 respectively arranged between adjacent leaf springs in stacked direction among the plural leaf springs, at least at both end parts of the laminated leaf spring.

16. A laminated leaf spring constituted by plural leaf springs which are stacked and bundled together, wherein the laminated leaf spring has the silencers for laminated leaf spring according to claim 9 respectively arranged between adjacent leaf springs in stacked direction among the plural leaf springs, at least at both end parts of the laminated leaf spring.
